(19) United States
(12) Patent Application Publication
(10) Pub. No.: US 2014/0015470 A1
(43) Pub. Date: Jan. 16, 2014

(54) WEARABLE WIRELESS POWER TRANSMISSION APPARATUS AND WIRELESS POWER TRANSMISSION METHOD USING THE SAME

(71) Applicant: Electronics and Telecommunications Research Institute, Daejeon-city (KR)

(72) Inventors: In-Gi LIM, Daejeon (KR); Sung-Weon KANG, Daejeon (KR); Chang-Hee HYOUNG, Daejeon (KR); Kyung-Hwan PARK, Daejeon (KR); Sung-Eun KIM, Daejeon (KR); Tae-Wook KANG, Daejeon (KR); Hyung-Il PARK, Daejeon (KR); Jung-Hwan HWANG, Daejeon (KR); Byoung-Gun CHOI, Daejeon (KR); Tae-Young KANG, Seoul (KR); Jung-Bum KIM, Daejeon (KR); Kyung-Soo KIM, Daejeon (KR); Myung-Ae CHUNG, Daejeon (KR)

(21) Appl. No.: 13/920,525

(22) Filed: Jun. 18, 2013

(30) Foreign Application Priority Data
Jul. 11, 2012 (KR) 10-2012-0075413

(51) Int. Cl. H02J 7/35; H02J 7/02

(52) U.S. Cl. CPC H02J 7/35; H02J 7/025
USPC 320/101

(57) ABSTRACT

Disclosed herein are a wearable wireless power transmission apparatus and a wearable wireless power transmission using the same. The apparatus includes a wearable energy harvesting unit, a wearable battery unit, a wearable power charging unit, a wearable power transmission processing unit, and a fiber-type primary coil unit. The wearable energy harvesting unit generates power from at least one of light energy and kinetic energy, and is attachable to fabric. The wearable battery unit stores the power, and is attachable and detachable to and from the fabric. The wearable power charging unit rectifies the power, charges the wearable battery unit, and is attachable and detachable to and from the fabric. The wearable power transmission processing unit generates a transmission signal, and is attachable and detachable to and from the fabric. The fiber-type primary coil unit wirelessly transmits the transmission signal to the secondary coil unit of the power reception terminal.

### CROSS REFERENCE TO RELATED APPLICATION

This application claims the benefit of Korean Patent Application No. 10-2012-0075413, filed on Jul. 11, 2012, which is hereby incorporated by reference in its entirety into this application.

### BACKGROUND OF THE INVENTION

1. Technical Field

The present invention relates generally to a wearable wireless power transmission apparatus and a wearable wireless power transmission method using the same and, more particularly, to a wearable wireless power transmission apparatus that, when a user stays in a place where power cannot be supplied, can be attached to an article worn or carried by the user, such as a garment or a bag, can generate power by converting light energy or mechanical kinetic energy into electrical energy, and can wirelessly transmit power to the user's portable mobile terminal, and a wearable wireless power transmission method using the same.

2. Description of the Related Art

Recently, with the popularization of the provision of services via portable mobile devices without temporal and spatial limitations thanks to a ubiquitous computing and communication environment, the inconvenience of frequently charging potable mobile devices is caused to users. Accordingly, the demand for a self-contained power generation system that enables a user to be supplied with power at a desired time and in a desired place is increasing, and the management of IT convergence harvesting energy is required. In particular, when a user stays in an outdoor place where power cannot be supplied in order to enjoy outdoor activities, such as camping, mountain hiking or cycling, the user should suffer from the inconvenience of carrying additional equipment, such as a separate auxiliary battery or a portable solar light charger, to charge a portable mobile device with power.

In this connection, Korean Patent Application Publication No. 2011-0132190 discloses technology that generates an electromagnetic field in a wireless charging pad using a solar cell, such as a dye-sensitized solar cell (DSSC) or a thin-film solar cell, without requiring a separate power code and charges a battery using induced current generated by a magnetic induction phenomenon via an induced current receiver coil provided inside a small-sized electronic device.

However, the conventional technology of charging a portable mobile device using a solar cell, which is disclosed in Korean Patent Application Publication No. 2011-0132190, cannot generate power when there is no solar light or no indoor light, and does not allow a corresponding system to be attached to a garment or a bag worn or carried by a user because a dye-sensitized solar cell or a thin-film solar cell is used and the primary coil of a wireless power transmission apparatus is implemented inside a plastic cover. Accordingly, even when a user stays in an outdoor place where power cannot be supplied in order to enjoy outdoor activities, such as camping, mountain hiking or cycling, the user suffers from the inconvenience of carrying the wireless power transmission apparatus to charge the portable mobile device. Furthermore, there arises a problem in that it is difficult to fasten a portable mobile device at a specific location where the portable mobile device can be charged with power via the wireless power transmission apparatus while a user is moving.

### SUMMARY OF THE INVENTION

Accordingly, the present invention has been made keeping in mind the above problems occurring in the prior art, and an object of the present invention is to provide a wearable wireless power transmission apparatus that includes an energy harvesting function of converting light energy or kinetic energy attributable to bodily activities into electrical energy, so that a portable mobile device can be charged through automatic wireless power transmission by simply putting the portable mobile device in the pocket of a garment or a bag even when the user stays in an outdoor place where power cannot be supplied in order to enjoy outdoor activities, such as camping, mountain hiking or cycling.

In accordance with an aspect of the present invention, there is provided a wearable wireless power transmission apparatus, including a wearable energy harvesting unit configured to generate power from at least one of light energy and kinetic energy, and to be attachable to fabric; a wearable battery unit configured to store the power generated by the wearable energy harvesting unit, to be attachable and detachable to and from the fabric, and to be charged with external power when it is detached from the fabric; a wearable power charging unit configured to rectify the power generated by the wearable energy harvesting unit, to charge the wearable battery unit with the power, and to be attachable and detachable to and from the fabric; a wearable power transmission processing unit configured to generate a transmission signal to be used to wirelessly transmit the power stored in the wearable battery unit to a power reception terminal, and to be attachable and detachable to and from the fabric; and a fiber-type primary coil unit configured to wirelessly transmit the transmission signal generated by the wearable power transmission processing unit to a secondary coil unit of the power reception terminal, configured of conductive fiber, and formed in the fabric.

The wearable energy harvesting unit may include a first power generation unit configured to generate power by converting light energy into electrical energy, and to be configured of a fiber-type solar cell.

The wearable energy harvesting unit may include a second power generation unit configured to generate power by converting kinetic energy into electrical energy, and to be configured of a fiber-type dielectric elastomer.

The wearable battery unit, the wearable power charging unit, and the wearable power transmission processing unit are implemented as a System On Package (SOP), and are configured as a single package that can be attachable and detachable to and from the fabric.

The wearable wireless power transmission apparatus may further include a wearable state display unit configured to display at least one of the charged state of the wearable battery unit and the transmission state of the power transmitted from the fiber-type primary coil unit to the secondary coil unit, via a flexible light-emitting diode.

The wearable state display unit may be configured such that a display mode thereof is controlled by the manipulation of a user input unit provided in the wearable state display unit or by the manipulation of the power reception terminal.

The display mode may correspond to any one of a constant ON mode, a constant OFF mode, a battery charged state display mode, a power transmission state display mode, and a flickering mode.

The wearable power charging unit may include a power input unit configured to receive alternating current (AC) power generated by the wearable energy harvesting unit, and to convert the AC power into direct current (DC) power; and a power conversion unit configured to perform DC-DC conversion on the DC power obtained by the rectification of the power input unit, and to charge the wearable battery unit.

The wearable power charging unit may further include a charging state monitoring unit configured to monitor the charged state of the wearable battery unit.

The wearable power transmission processing unit may include a transmission signal generation unit configured to generate the transmission signal to be used to wirelessly transmit the power stored in the wearable battery unit to the power reception terminal; and a transmission control unit configured to determine the presence of the power reception terminal, and to control the output of the transmission signal.

The wearable power transmission processing unit may further include a transmission state monitoring unit configured to monitor the transmission state of the power transmitted from the fiber-type primary coil unit to the secondary coil unit.

The charged state of the wearable battery unit monitored by the charging state monitoring unit or the transmission state of the power monitored by the transmission state monitoring unit is displayed on the power reception terminal.

In accordance with another aspect of the present invention, there is provided a wearable wireless power transmission method, including generating, by a wearable energy harvesting unit attachable to fabric, AC power from at least one of light energy and kinetic energy; converting, by a wearable power charging unit attachable and detachable to and from the fabric, the AC power into DC power; storing, by a wearable battery unit attachable and detachable to and from the fabric, the DC power; generating, by a wearable power transmission processing unit attachable and detachable to and from the fabric, a transmission signal to be used to wirelessly transmit the power stored in the wearable battery unit to a power reception terminal; and wirelessly transmitting, by a fiber-type primary coil unit configured of conductive fiber and formed in the fabric, the transmission signal to a secondary coil unit of the power reception terminal; wherein the wearable battery unit, the wearable power charging unit, and the wearable power transmission processing unit are implemented as an SOP, and are configured as a single package that can be attachable and detachable to and from the fabric.

The wearable wireless power transmission method may further include monitoring, by the wearable power charging unit, the charged state of the wearable battery unit; monitoring, by the wearable power transmission processing unit, the transmission state of the power transmitted from the fiber-type primary coil unit to the secondary coil unit; and displaying, by a wearable state display unit, at least one of the charged state and the transmission state via a flexible light-emitting diode.

Displaying at least one of the charged state and the transmission state via the flexible light-emitting diode may include displaying the charged state or the transmission state in accordance with a display mode that is controlled by the manipulation of a user input unit provided in the wearable state display unit or by the manipulation of the power reception terminal.

The wearable wireless power transmission method may further include displaying the charged state or the transmission state on the power reception terminal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the concept that a wearable wireless power transmission apparatus in accordance with the present invention wirelessly supplies power to a power reception terminal;

FIG. 2 is a block diagram illustrating the configuration of the wearable wireless power transmission apparatus in accordance with an embodiment of the present invention;

FIG. 3 is a block diagram illustrating the configuration of the wearable energy harvesting unit illustrated in FIG. 2;

FIG. 4 is a block diagram illustrating the configuration of the wearable power charging unit illustrated in FIG. 2;

FIG. 5 is a block diagram illustrating the configuration of the wearable power transmission processing unit illustrated in FIG. 2;

FIG. 6 is a block diagram illustrating the configuration of the wearable state display unit illustrated in FIG. 2;

FIG. 7 is a block diagram illustrating the configuration of a power reception terminal in accordance with an embodiment of the present invention;

FIG. 8 is a diagram illustrating the attachment of the wearable wireless power transmission apparatus in accordance with the present invention to a garment in accordance with an embodiment of the present invention;

FIG. 9 is a diagram illustrating the attachment of the wearable wireless power transmission apparatus in accordance with the present invention to a bag in accordance with another embodiment of the present invention; and

FIG. 10 is a flowchart illustrating a wireless power transmission method in accordance with the present invention.

### DESCRIPTION OF THE PREFERRED EMBODIMENTS

A wearable wireless power transmission apparatus and a wearable wireless power transmission using the same in accordance with embodiments of the present invention will be described with reference to the accompanying drawings. Prior to the detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the examples at the time at which the present application is filed.

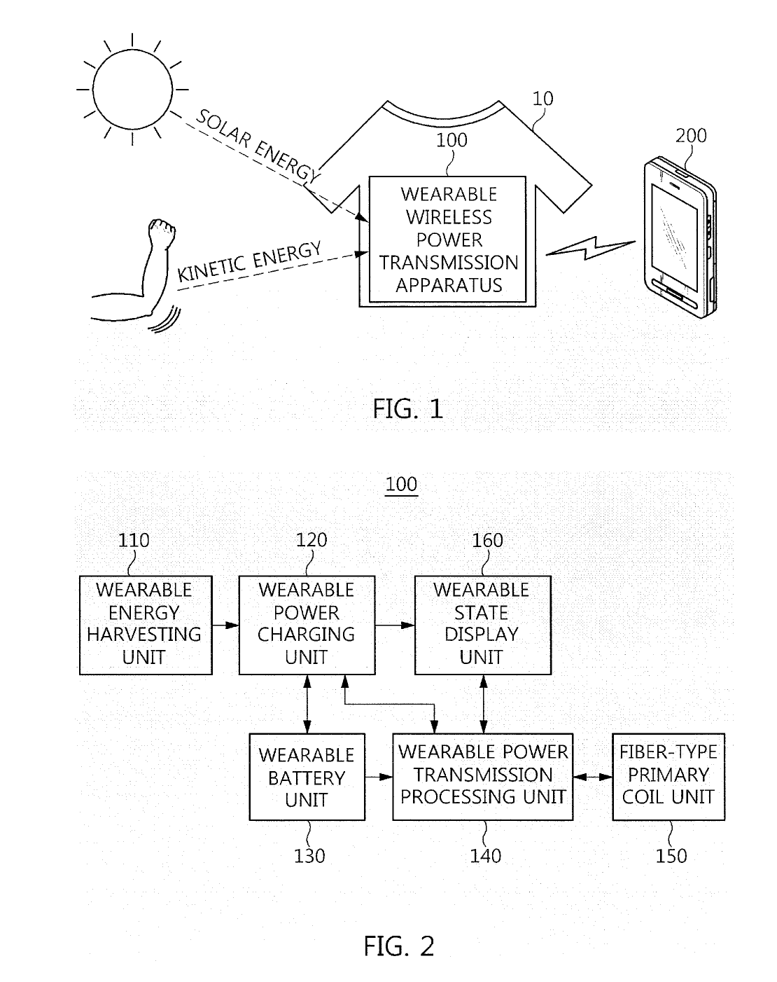

The configuration and operation of a wearable wireless power transmission apparatus 100 in accordance with the present invention will be described with reference to FIGS. 1 to 6 below.

FIG. 1 is a diagram illustrating the concept that the wearable wireless power transmission apparatus 100 in accordance with the present invention wirelessly supplies power generated by performing an energy harvesting function, to the user's power reception terminal.

Referring to FIG. 1, the wearable wireless power transmission apparatus 100 in accordance with the present invention is attached to the fabric of an article 10 worn or carried by a user, such as the user's garment or bag, and, when the user stays in a place where power cannot be supplied from a fixed power source (e.g., an outdoor place), generates power by receiving solar light or illumination light and then converting light energy into electrical energy, or by converting kinetic energy attributable to the user's motion into electrical energy.

Here, the wearable wireless power transmission apparatus 100 stores the generated power in an internal battery, and wirelessly transmits the power stored in the battery to a power reception terminal 200 using a magnetic induction method using primary and secondary coils or a magnetic resonance method when the user's power reception terminal 200, such as a portable mobile device, becomes proximate to the wearable wireless power transmission apparatus 100. Although for ease of description, the user's power reception terminal 200 is illustrated as being located outside the article 10 worn or carried by the user in FIG. 1, wireless power transmission can be performed when the user's power reception terminal 200 is put in a pocket provided in the user's garment or bag and becomes proximate to the wearable wireless power transmission apparatus 100 attached to the user's garment or bag. In the following description, the article 10 worn or carried by the user will be described as a garment or a bag by way of an example. It will be apparent that the garment or bag is merely an example of the article 10 and the article 10 is not limited thereto.

FIG. 2 is a block diagram illustrating the configuration of the wearable wireless power transmission apparatus in accordance with an embodiment of the present invention.

Referring to FIG. 2, the wearable wireless power transmission apparatus 100 in accordance with the present invention includes a wearable energy harvesting unit 110, a wearable power charging unit 120, a wearable battery unit 130, a wearable power transmission processing unit 140, a fiber-type primary coil unit 150, and a wearable state display unit 160.

The wearable energy harvesting unit 110 is attached to the fabric of an article worn or carried by the user, such as a garment or a bag, and generates power from light energy or kinetic energy.

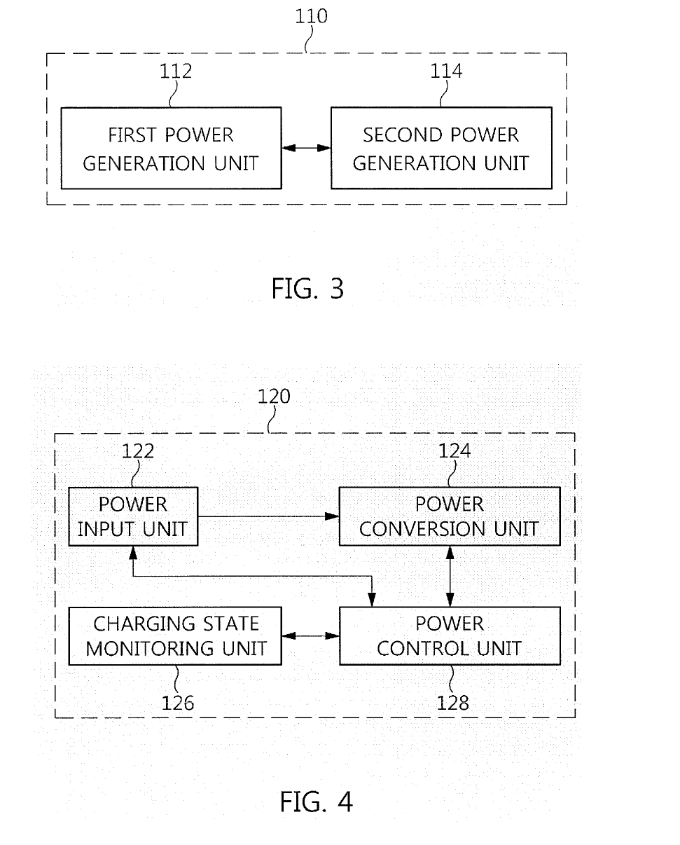

Referring to FIG. 3, the wearable energy harvesting unit 110 includes a first power generation unit 112 based on a fiber-type solar cell and a second power generation unit 114 based on a fiber-type dielectric elastomer.

When the user who wears or carries the garment or bag to which the wearable wireless power transmission apparatus 100 has been attached stays indoors or outdoors, the first power generation unit 112 based on a fiber-type solar cell generates power by receiving solar light or illumination light and then converting light energy into electrical energy. Here, the first power generation unit 112 may be implemented by producing dye-sensitized solar cell fiber having a one-dimensional fiber structure by electro-spinning polymer nanofiber, weaving fabric, and then stacking and modularizing the fabric. That is, the first power generation unit 112 is implemented as fiber functioning as a solar cell, and thus has characteristics intrinsic to fiber, such as flexibility and washability, like typical fiber, thus being attached to the user's garment, bag, or the like without incompatibility. Since a fiber-type solar cell-based energy harvesting technology is well known not only to the field of garment products, such as a garment and a bag but also to the field of interior fiber products, such as an awning, a curtain and blinds, and the field of living fiber products, such as a parasol, a detailed description thereof is omitted herein.

The second power generation unit 114 based on a fiber-type dielectric elastomer generates power by converting kinetic energy, generated by the user's bodily activities, into electrical energy. The dielectric elastomer of the second power generation unit 114 may be configured of a combination of polyvinlylidene fluorid (PVDF) that is a polymer material having the highest dielectric constant, is flexible, and has high tensile strength, and a Carbon Nanotube (CNT) that recently attracts the highest attention in the field of research into nano-composite material, has a maximum of strength 100 times that of steel having the same thickness because carbons form a hexagonal structure, and has thermal conductivity twice that of diamond. Here, the second power generation unit 114 is implemented in the form of a band made of the above-described dielectric elastomer, so that it may be mounted around the elbow or lap portion of a garment and harvest energy by converting mechanical deformation attributable to bodily activities into electrical energy. Meanwhile, since a technology for converting mechanical kinetic energy into electrical energy using a fiber-type dielectric elastomer is well known from, for example, a paper of Thomas G. McKay, Benjamin M. O'Brien, Emilio P. Calius, Iain A. Anderson, entitled “Soft Generators using Dielectric Elastomers,” Applied Physics Letters, 2011; 98 (14): 142903 DOI: 10.1063/1.3572338, a detailed description thereof is omitted herein.

Meanwhile, the wearable energy harvesting unit 110 may include only the first power generation unit 112 that is based on a fiber-type solar cell, which are means that can most stably supply power when the user stays both in an outdoor place where solar light is radiated and in an indoor place where illumination light is radiated. In contrast, when the user stay in a place where neither solar light nor indoor light are radiated, only the second power generation unit 114 that is based on a fiber-type dielectric elastomer may be used. Furthermore, it will be apparent that in some cases, both of the two types of energy harvesting means, that is, both the first power generation unit 112 based on a fiber-type solar cell and the second power generation unit 114 based on a fiber-type dielectric elastomer may be used at the same time. Moreover, the wearable energy harvesting unit 110 transmits the power generated by the first power generation unit 112 based on a fiber-type solar cell and the second power generation unit 114 based on a fiber-type dielectric elastomer, to the wearable power charging unit 120.

The wearable power charging unit 120 rectifies the power generated by the wearable energy harvesting unit 110, and charges the wearable battery unit 130 with the power.

Referring to FIG. 4, the wearable power charging unit 120 includes a power input unit 122, a power conversion unit 124, a charging state monitoring unit 126, and a power control unit 128.

The power input unit 122 performs the functions of rectifying and monitoring the power generated by the wearable energy harvesting unit 110 and the function of preventing reverse current. More specifically, the power input unit 122 receives AC power generated by the first power generation unit 112 and the second power generation unit 114, and converts the AC power into DC power that can be charged into the wearable battery unit 130. Here, the power input unit 122 performs the rectifying operation of obtaining DC power from AC power, and may use a circuit device capable of passing current only in a single direction for this purpose. Furthermore, the power input unit 122 blocks reverse current that may flow from the wearable battery unit 130 to the wearable energy harvesting unit 110 if the power charged in the wearable battery unit 130 is higher than power that is input via the wearable energy harvesting unit 110. Furthermore, the power input unit 122 monitors the power input via the wearable energy harvesting unit 110 and provides the results of the monitoring to the power control unit 128, and, if input power is lower than a preset minimum reference value Pₘᵢₙ, prevents the AC power generated by the wearable energy harvesting unit 110 from being input in order to reduce unnecessary power consumption under the control of the power control unit 128. Thereafter, the power input unit 122 detects that the input power becomes higher than the preset minimum reference value Pₘᵢₙ, and receives AC power from the wearable energy harvesting unit 110 under the control of the power control unit 128.

The power conversion unit 124 receives the DC power, obtained by the rectification, from the power input unit 122, performs DC-DC conversion, and charges the wearable battery unit 130 with the power. Furthermore, the power conversion unit 124 performs the function of preventing the excessive charging of the wearable battery unit 130 and the function of preventing the excessive discharging thereof. More specifically, in order to prevent the excessive charging of the wearable battery unit 130, the power conversion unit 124 prevents the wearable battery unit 130 from being charged with power under the control of the power control unit 128 if the power with which the wearable battery unit 130 has been charged is equal to or higher than a preset first reference value P₁ based on a value in the case where the wearable battery unit 130 has been fully charged. In contrast, in order to prevent the excessive discharging of the wearable battery unit 130, the power conversion unit 124 prevents the discharge of power from the wearable battery unit 130 to the wearable power transmission processing unit 140 under the control of the power control unit 128 if the power with which the wearable battery unit 130 has been charged is equal to or lower than a preset second reference value P₂ based on a value in the case where power has been discharged from the wearable battery unit 130. Here, it will be apparent that the first reference value P₁ preset to prevent the excessive charging of the wearable battery unit 130 is higher than the second reference value P₂ preset to prevent the excessive discharging of the wearable battery unit 130.

The charging state monitoring unit 126 monitors the charged state of the wearable battery unit 130, and provides information about the charged state of the wearable battery unit 130 to the power control unit 128 and the wearable state display unit 160. The information about the charged state of the wearable battery unit 130 monitored by the charging state monitoring unit 126 may be charged power information or charged voltage information.

The power control unit 128 controls the power input unit 122 and the power conversion unit 124. More specifically, the power control unit 128 compares the input power monitored by the power input unit 122 with the minimum reference value Pₘᵢₙ, and, if the input power is equal to or lower than the minimum reference value Pₘᵢₙ, prevents the AC power generated by the wearable energy harvesting unit 110 from being input to the power input unit 122 by controlling the power input unit 122 and stops the operation of the power conversion unit 124. In contrast, if the input power is equal to or higher than the minimum reference value Pₘᵢₙ, the power control unit 128 allows the AC power generated by the wearable energy harvesting unit 110 to be input to the power input unit 122 by controlling the power input unit 122, and initiates the operation of the power conversion unit 124. Furthermore, the power control unit 128 compares the charged power of the wearable battery unit 130 with a preset first reference value P₁ based on the information about the charged state of the wearable battery unit 130 received from the charging state monitoring unit 126, and, if the charged power of the wearable battery unit 130 is equal to or higher than the preset first reference value P₁, prevents the wearable battery unit 130 from being charged with power by controlling the power conversion unit 124 in order to prevent the excessive charging of the wearable battery unit 130. Here, the function of controlling the prevention of the excessive charging of the wearable battery unit 130 performed by the power control unit 128 may be performed using an On/Off method of controlling the flow of current by repeating the operation of alternately blocking and allowing the flow of current to the wearable battery unit 130, a Pulse Width Modulation (PWM) method of controlling the flow of current by gradually increasing or decreasing the flow of current to the wearable battery unit 130, or a Maximum Power Point Tracking (MPPT) method of calculating the maximum charging efficiency by matching the input power transferred from the power input unit 122 to the charged voltage of the wearable battery unit 130 provided by the charging state monitoring unit 126. Furthermore, the power control unit 128 compares the charged power of the wearable battery unit 130 with a preset second reference value P₂, and, if the charged power of the wearable battery unit 130 is lower than the preset second reference value P₂, blocks the discharge of power from the wearable battery unit 130 to the wearable power transmission processing unit 140 in order to prevent the excessive discharging of the wearable battery unit 130. Meanwhile, in order to compensate for the phenomenon that the charging and discharging characteristics of the battery vary depending on temperature, the power control unit 128 may detect the temperature of the wearable battery unit 130, and adjust the preset first reference value P₁ and the preset second reference value P₂ based on the detected temperature of the wearable battery unit 130.

The wearable battery unit 130 stores the power generated by the wearable energy harvesting unit 110. More specifically, the wearable battery unit 130 stores DC power obtained by the rectification and DC-DC conversion of the wearable power charging unit 120 with respect to the AC power generated by the wearable energy harvesting unit 110, and transmits the stored power to the wearable power transmission processing unit 140. Here, the wearable battery unit 130 may be configured to be detachably attached to the fabric of the user's garment or bag and to be charged with power from the outside when it is detached from the fabric of the user's garment or bag.

The wearable power transmission processing unit 140 is provided with the stored power by the wearable battery unit 130, and generates a transmission signal that is used to transmit the provided power to the user's power reception terminal 200.

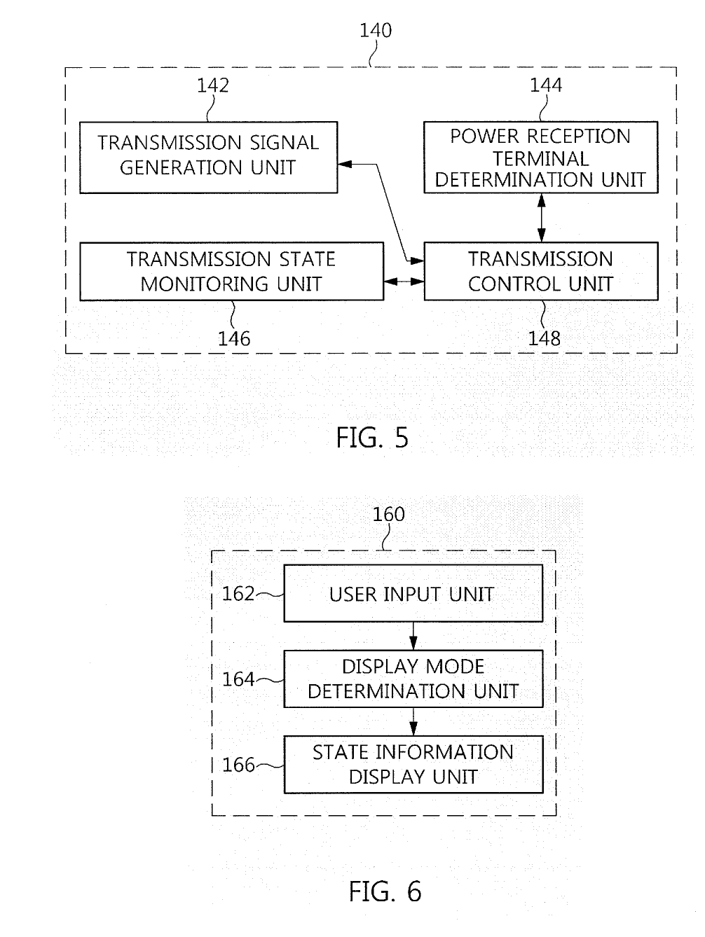

Referring to FIG. 5, the wearable power transmission processing unit 140 includes a transmission signal generation unit 142, a power reception terminal determination unit 144, a transmission state monitoring unit 146, and a transmission control unit 148.

The transmission signal generation unit 142 generates a transmission signal that is used to wirelessly transmit the power provided by the wearable battery unit 130 to the user's power reception terminal 200. That is, the transmission signal generation unit 142 generates a transmission signal to be used to wirelessly transmit power from the fiber-type primary coil unit 150 to the secondary coil unit of the user's power reception terminal 200 using a magnetic induction method or a magnetic resonance method conformable to Qi, that is, the global interoperable standard for wireless charging developed by the Wireless Power Consortium (WPC), and provides the transmission signal to the fiber-type primary coil unit 150. Here, the generation of a transmission signal by the transmission signal generation unit 142 and the size of a generated transmission signal may be determined by the control of the transmission control unit 148.

The power reception terminal determination unit 144 determines whether the power reception terminal 200 is present, and detects the location of the power reception terminal 200. If there is no user's power reception terminal 200 proximate to the wearable wireless power transmission apparatus 100 in accordance with the present invention, or if the power reception terminal 200 does not need to be charged even when there is the user's power reception terminal 200 proximate to the wearable wireless power transmission apparatus 100, the wearable wireless power transmission apparatus 100 needs to operate in standby power mode in order to minimize power consumption. For this purpose, the power reception terminal determination unit 144 detects the presence and location of the proximate power reception terminal 200 using a sensor for detecting changes in capacitance or resonant frequency, and provides the results of the detection of the presence and location of the power reception terminal 200 to the transmission control unit 148.

The transmission state monitoring unit 146 monitors the transmission state of the power transmitted from the fiber-type primary coil unit 150 to the secondary coil unit of the power reception terminal 200, and provides the results of the monitoring to the wearable state display unit 160. Here, when power is transmitted from the fiber-type primary coil unit 150 to the secondary coil unit of the power reception terminal 200, the transmission state monitoring unit 146 may generate a digital signal having a value of “1,” and transmit it to the wearable state display unit 160.

The transmission control unit 148 controls the transmission signal generation unit 142, the power reception terminal determination unit 144, and the transmission state monitoring unit 146. Here, the transmission control unit 148 receives the results of the detection of the presence and location of the user's power reception terminal 200 proximate to the wearable wireless power transmission apparatus 100 from the power reception terminal determination unit 144, determines the presence and location of the power reception terminal 200, and controls the generation of a transmission signal and the size of the generated transmission signal by controlling the transmission signal generation unit 142 based on the results of the determination.

The fiber-type primary coil unit 150 receives the transmission signal from the wearable power transmission processing unit 140, and wirelessly transmits power to the secondary coil unit of the power reception terminal 200. That is, the fiber-type primary coil unit 150 receives the transmission signal generated by the transmission signal generation unit 142 of the wearable power transmission processing unit 140, and wirelessly transmits the power stored in the wearable battery unit 130 to the secondary coil unit of the power reception terminal 200 using a magnetic induction method or a magnetic resonance method. Here, the primary coil of the fiber-type primary coil unit 150 may be implemented by fixing, by weaving or embroidering, conductive fiber (metallic fiber or conductive fiber) having flexibility and washability into the specific portion (pocket) of a garment or a bag to which the wearable wireless power transmission apparatus 100 is attached. Furthermore, the fiber-type primary coil unit 150 may transmit the information about the charged state of the wearable battery unit 130 monitored by the charging state monitoring unit 126 and the information about the transmission state of the power monitored by the transmission state monitoring unit 146 to the secondary coil unit of the power reception terminal 200. Here, the transmission of the information about the charged state of the wearable battery unit 130 and the information about the transmission state of the power may be performed via data communication between the fiber-type primary coil unit 150 and the secondary coil unit of the power reception terminal 200.

The wearable state display unit 160 displays the information about the charged state of the wearable battery unit 130 provided by the charging state monitoring unit 126 of the wearable power charging unit 120 and the information about the transmission state of the power provided by the transmission state monitoring unit 146 of the wearable power transmission processing unit 140 to the user. Furthermore, the display mode of the wearable state display unit 160 is controlled by the user's setting and then displays the information about the charged state of the wearable battery unit 130 and the information about the transmission state of the power.

Referring to FIG. 6, the wearable state display unit 160 includes a user input unit 162, a display mode determination unit 164, and a state information display unit 166.

The user input unit 162 receives the setting of display mode, that is, a method of displaying the information about the charged state of the wearable battery unit 130, and the information about the transmission state of power from the user. Here, the display mode selected via the user input unit 162 may be, for example, a constant ON mode, a constant OFF mode, a battery charged state display mode, a power transmission state display mode, a flickering mode, or the like. The user input unit 162 transfers information about the setting of the display mode received from the user, to the display mode determination unit 164.

The display mode determination unit 164 receives the information about the setting of the display mode from the user input unit 162, and determines the display mode of the state information display unit 166. Meanwhile, the wearable state display unit 160 may not be provided with the user input unit 162, and receives the setting of the display mode through the manipulation of the user's power reception terminal 200. When the user executes an application implemented as software on a portable mobile device, that is, the power reception terminal 200, and inputs the setting of the display mode, the display mode determination unit 164 may receive the setting of the display mode via data communication between the secondary coil unit of the power reception terminal 200 and the fiber-type primary coil unit 150, and determine the display mode of the wearable state information display unit 166. The display mode determination unit 164 provides the determined display mode to the state information display unit 166. It will be apparent that even when the wearable state display unit 160 is provided with the user input unit 162, the display mode determination unit 164 may receive the setting of the display mode via the manipulation of the power reception terminal 200.

The state information display unit 166 receives the display mode from the display mode determination unit 164, and displays the information about the charged state of the wearable battery unit 130 and the information about the transmission state of the power to the user using a corresponding display method. Here, the state information display unit 166 may be implemented as a flexible light-emitting diode (e.g., a fiber-type light emitting diode) having a form, such as a logo formed on the surface of a garment or a bag and designed to indicate a brand name or a manufacturer name, and indicates the information about the charged state of the wearable battery unit 130 and the information about the transmission state of the power using the color of the light-emitting diode, the speed of flickering, or the difference in the brightness of the light-emitting diode.

Meanwhile, since in the wearable wireless power transmission apparatus 100 in accordance with the present invention, the wearable battery unit 130, the wearable power charging unit 120 and the wearable power transmission processing unit 140 are all implemented as electronic parts, the wearable wireless power transmission apparatus 100 may be damaged by bending and impact that occurs when a garment or a bag is washed. Accordingly, in the wireless power transmission apparatus 100 in accordance with the present invention, the wearable power charging unit 120, the wearable battery unit 130 and the wearable power transmission processing unit 140 may be implemented as a single package attachable to a garment or a bag using a System On Package (SOP) method. In this case, when the user desires to wash the garment or bag, he or she may detach the single package, including the wearable power charging unit 120, the wearable battery unit 130 and the wearable power transmission processing unit 140, from the garment and bag, and separately charge it.

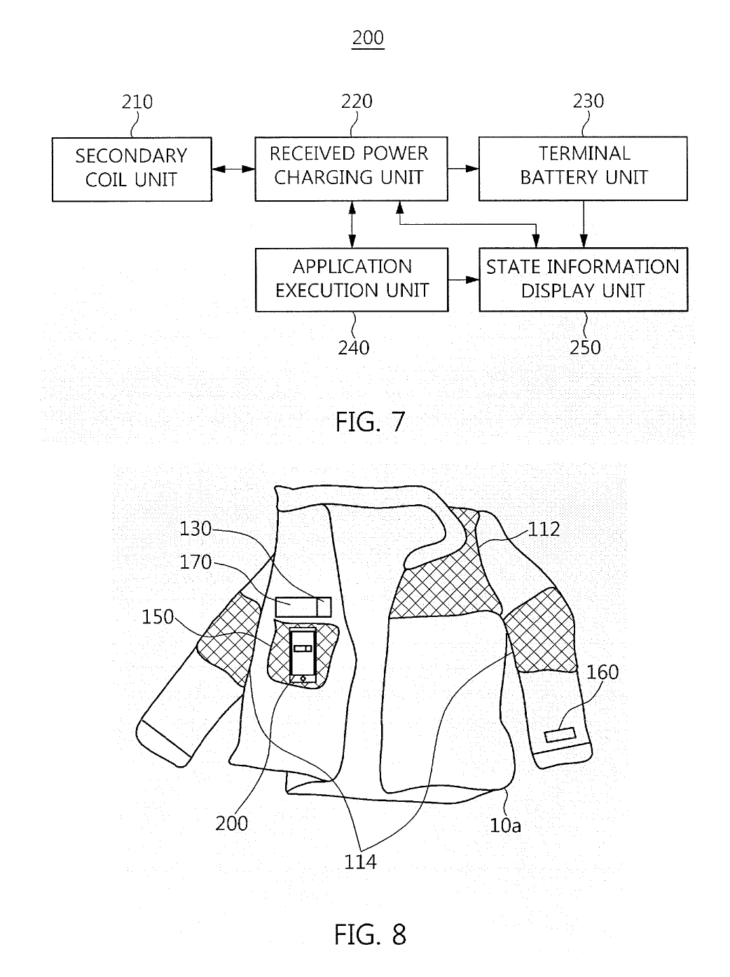

FIG. 7 is a block diagram illustrating the configuration of the user's power reception terminal 200 that can be wirelessly supplied with power by the wearable wireless power transmission apparatus in accordance with an embodiment of the present invention.

Referring to FIG. 7, the power reception terminal 200 in accordance with the present invention includes a secondary coil unit 210, a received power charging unit 220, a terminal battery unit 230, an application execution unit 240, and a state information display unit 250. The user may perform charging through wireless power transmission by putting the power reception terminal 200 in accordance with the present invention in the packet of the garment or bag to which the wearable wireless power transmission apparatus 100 has been attached.

The secondary coil unit 210 wirelessly receives power from the fiber-type primary coil unit 150 of the wearable wireless power transmission apparatus 100. That is, once a transmission signal has been input to the fiber-type primary coil unit 150 of the wearable wireless power transmission apparatus 100, power is transferred to the secondary coil of the secondary coil unit 210 using a magnetic induction method or a magnetic resonance method.

The received power charging unit 220 converts the power to be transferred to the secondary coil of the secondary coil unit 210 and charges the terminal battery unit 230 with the power, and the terminal battery unit 230 supplies power to individual modules that constitute the power reception terminal 200. Furthermore, the received power charging unit 220 may receive the information about the charged state of the wearable battery unit 130 and the information about the transmission state of the power from the wearable wireless power transmission apparatus 100 via data communication between the secondary coil unit 210 and the fiber-type primary coil unit 150, and transmit them to the state information display unit 250. Furthermore, the received power charging unit 220 may receive information about the setting of the display mode from the application execution unit 240, and transmit it to the wearable wireless power transmission apparatus 100 via data communication between the secondary coil unit 210 and the fiber-type primary coil unit 150. Furthermore, the received power charging unit 220 may transmit the unique ID of the power reception terminal 200 and information about the amount of power necessary to charge the terminal battery unit 230 to the wearable wireless power transmission apparatus 100 via data communication between the secondary coil unit 210 and the fiber-type primary coil unit 150. In this case, the wearable wireless power transmission apparatus 100 may adjust the strength of a transmission signal input to the fiber-type primary coil unit 150 via the transmission control unit 148 based on the received unique ID and the information about the amount of power.

The application execution unit 240 executes an application implemented as software so that the user may input the setting of the display mode, and, if the user inputs the setting of the display mode, provides information about the setting of the display mode to the received power charging unit 220 and the state information display unit 250.

The state information display unit 250 displays the received information about the charged state of the wearable battery unit 130 and the received information about the transmission state of the power to the user through the fiber-type primary coil unit 150, the secondary coil unit 210 and the received power charging unit 210 in accordance with the information about the setting of the display mode provided by the application execution unit 240. Here, it is preferred that the state information display unit 250 display the information about the charged state of the wearable battery unit 130 and the information about the transmission state of the power when the user executes the application. Meanwhile, the power reception terminal 200 in accordance with the present invention may be provided with the state information display unit 250, and display the information about the charged state of the wearable battery unit 130 and the information about the transmission state of the power using information display means, such as a liquid crystal display (LCD) or an organic light-emitting diode (OLED) display mounted on an existing portable mobile device.

FIG. 8 is a diagram illustrating the attachment of the wearable wireless power transmission apparatus in accordance with the present invention to a garment in accordance with an embodiment of the present invention.

Referring to FIG. 8, the fiber-type solar cell-based first power generation unit 112 is attached to the shoulder and chest portions of a garment 10a, and thus can generate power by converting light energy into electrical energy. Furthermore, the fiber-type dielectric elastomer-based second power generation unit 114 is attached to the elbow portion of the garment 10a, and thus can generate power by converting mechanical kinetic energy attributable to the motion of the user into electrical energy. The power generated by the first power generation unit 112 attached to the shoulder and chest portions of the garment 10a and the second power generation unit 114 attached to the elbow portion of the garment 10a is input to a single package 170 including the wearable power charging unit 120, the wearable battery unit 130 and the wearable power transmission processing unit 140. The power input to the wearable power charging unit 120 of the single package 170 is rectified, DC-DC converted, and stored in the wearable battery unit 130. The power stored in the wearable battery unit 130 is converted into a transmission signal in the wearable power transmission processing unit 140, and is then output to the fiber-type primary coil unit 150 having flexibility and washability since it is implemented as conductive fiber in the pocket of the garment 10a. When the user desires to charge the power reception terminal 200 with power, he or she checks the charged state of the wearable battery unit 130 displayed by the wearable state display unit 160, and, if the state is a chargeable state, wirelessly charges the power reception terminal 200 by putting the power reception terminal 200 in the pocket of the garment 10a. The state information display unit 166 of the wearable state display unit 160 is implemented as a flexible light-emitting diode having a form, such as a logo formed on the surface of the garment 10a and designed to indicate a brand name or a manufacturer name, and information about the charged state of the wearable battery unit 130 and information about the transmission state of the power are displayed using the color of the light-emitting diode, the speed of flickering, or the difference in the brightness of the light-emitting diode, so that the user can intuitively become aware of the information about the charged state of the wearable battery unit 130 and the information about the transmission state of the power. Furthermore, the single package 170 including the wearable power charging unit 120, the wearable battery unit 130 and the wearable power transmission processing unit 140 is configured to be selectively attached or detached to or from the user's garment 10a, so that when the user desires to wash the garment 10a, he or she may detach the single package 170 from the garment 10a, and separately charge the power reception terminal 200.

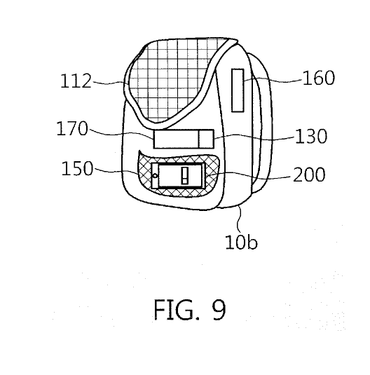

FIG. 9 is a diagram illustrating the attachment of the wearable wireless power transmission apparatus in accordance with the present invention to a bag in accordance with another embodiment of the present invention.

Referring to FIG. 9, the fiber-type solar cell-based first power generation unit 112 is attached to the upper portion or outside cover of a bag 10b, and thus generates power by converting light energy into electrical energy. The power generated by the first power generation unit 112 attached to the upper portion or outside cover of the bag 10b is input to the single package 170 including the wearable power charging unit 120, the wearable battery unit 130, and the wearable power transmission processing unit 140. The power input to the wearable power charging unit 120 of the single package 170 is rectified, DC-DC converted, and stored in the wearable battery unit 130. The power stored in the wearable battery unit 130 is converted into a transmission signal in the wearable power transmission processing unit 140, and is then output to the fiber-type primary coil unit 150 having flexibility and washability since it is implemented as conductive fiber in the pocket of the bag 10b. When the user desires to charge the power reception terminal 200, he or she checks the charged state of the wearable battery unit 130 displayed on the wearable state display unit 160, and, if the state is a chargeable state, wirelessly charges the power reception terminal 200 by putting the power reception terminal 200 in the pocket of the bag 10b. The state information display unit 166 of the wearable state display unit 160 is implemented as a flexible light-emitting diode having a form, such as a logo formed on the surface of the bag 10b and designed to indicate a brand name or a manufacturer name, and information about the charged state of the wearable battery unit 130 and information about the transmission state of the power are displayed using the color of the light-emitting diode, the speed of flickering, or the difference in the brightness of the light-emitting diode, so that the user can intuitively become aware of the information about the charged state of the wearable battery unit 130 and the information about the transmission state of the power. Furthermore, the single package 170 including the wearable power charging unit 120, the wearable battery unit 130 and the wearable power transmission processing unit 140 is configured to be selectively attached or detached to or from the user's bag 10b, so that when the user desires to wash the bag 10b, he or she may detach the single package 170 from the bag 10b, and separately charge the power reception terminal 200.

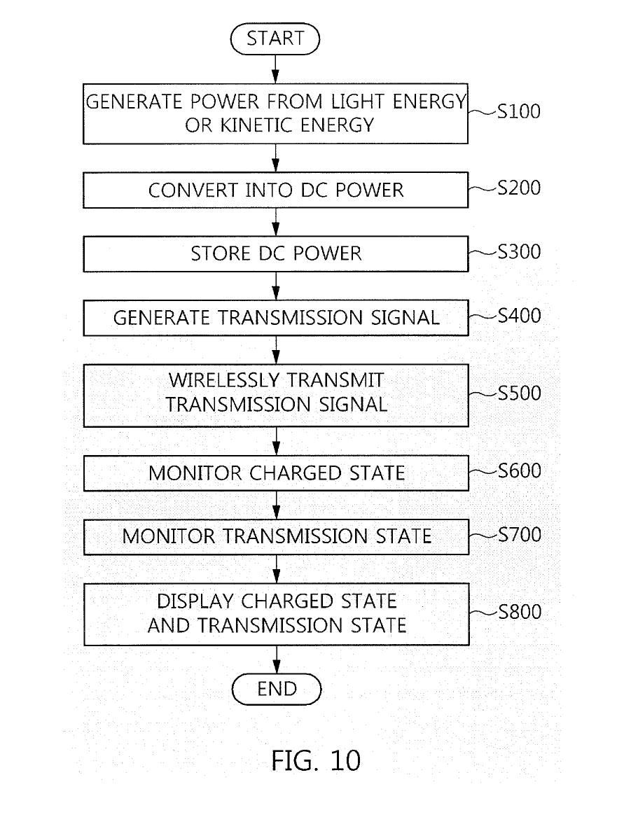

A wireless power transmission method in accordance with the present invention will be descried with reference to FIG. 10. The descriptions that are identical to those of the operations of the wearable wireless power transmission apparatus and the power reception terminal in accordance with the present invention given with reference to FIGS. 1 to 7 will be omitted.

FIG. 10 is a flowchart illustrating the wireless power transmission method in accordance with the present invention.

Referring to FIG. 10, in the wireless power transmission method in accordance with the present invention, the wearable energy harvesting unit 110 attachable to the fabric of the article worn or carried by the user 10 generates AC power by converting light energy or kinetic energy into electrical energy at step S100.

Thereafter, the wearable power charging unit 120 attachable to the fabric of the article 10 converts the AC power generated at step S100 into DC power at step S200, and stores the DC power in the wearable battery unit 130 detachably attachable to the fabric of the article 10 at step S300.

Thereafter, the wearable power transmission processing unit 140 detachably attachable to the fabric of the article 10 generates a transmission signal to be used to transmit the power stored in the wearable battery unit 130 at step S300 to the user's power reception terminal 200 at step S400, and the fiber-type primary coil unit 150 receives the transmission signal generated at step S400 and wirelessly transmits power to the secondary coil unit 210 of the power reception terminal 200 at step S500. Here, the fiber-type primary coil unit 150 is configured using conductive fiber and formed in the fabric of the article 10.

The charging state monitoring unit 126 of the wearable power charging unit 120 monitors the charged state of the wearable battery unit 130 at step S600, and the transmission state monitoring unit 146 of the wearable power transmission processing unit 140 monitors the transmission state of the power transmitted from the fiber-type primary coil unit 150 to the secondary coil unit 210 of the power reception terminal 200 at step S700. The information about the charged state of the wearable battery unit 130 acquired by the charging state monitoring unit 126 and the information about the transmission state of the power acquired by the transmission state monitoring unit 146 are transmitted to the wearable state display unit 160, and the state information display unit 166 of the wearable state display unit 160 displays the information about the charged state of the wearable battery unit 130 and the information about the transmission state of the power to the user in accordance with the display mode controlled by the manipulation of the user input unit 162 or display mode controlled by the manipulation of the power reception terminal 200 at step S800. Here, it is preferred that steps S600 to S800 and steps S300 to S500 be performed in parallel with each other and at the same time. Meanwhile, the information about the charged state of the wearable battery unit 130 acquired by the charging state monitoring unit 126 and the information about the transmission state of the power acquired by the transmission state monitoring unit 146 may be transmitted to the power reception terminal 200 via the fiber-type primary coil unit 150 and the secondary coil unit 210, and the power reception terminal 200 may display the received information about the charged state of the wearable battery unit 130 and the received information about the transmission state of the power to the user via the state information display unit 260.

As described above, in the conventional wireless power transmission system, the primary coil is implemented using metal on a Printed Circuit Board (PCB) or a plastic board, whereas in the wearable wireless power transmission apparatus 100 in accordance with the present invention, the fiber-type primary coil is implemented using conductive fiber (metallic fiber or conductive fiber) having flexibility and washability on the fabric of the article 10 worn or carried by the user, such as a garment or a bag, by means of a weaving or embroidering method. Furthermore, the fiber-type primary coil of the wearable wireless power transmission apparatus 100 in accordance with the present invention is disposed in a packet of a garment or a bag, and the user's power reception terminal 200, that is, a portable mobile device, having the secondary coil is stored in a pocket of the garment or bag to which the wearable wireless power transmission apparatus 100 has been attached, so that the primary coil of the wearable wireless power transmission apparatus 100 and the secondary coil of the power reception terminal 200 are located proximate to each other in an aligned arrangement. Accordingly, the present invention can overcome the problem of magnetic induction-type wireless power transmission technology in which power transmission efficiency may decrease when the distance between wireless power transmission means and wireless power reception means increases and an arrangement is biased, and also has the advantage of increasing wireless power transmission efficiency when a magnetic resonance method is employed.

Furthermore, the wearable power transmission processing unit 140 of the wearable wireless power transmission apparatus 100 in accordance with the present invention acquires state information by monitoring the transmission state of the power transmitted from the primary coil to the secondary coil, and the wearable state display unit 160 displays the information about the transmission state of the power acquired by the wearable power transmission processing unit 140 to a user via the light-emitting diode, so that user can intuitively be aware of whether the power is smoothly transmitted from the wearable wireless power transmission apparatus 100 to the power reception terminal 200.

Furthermore, the wearable wireless power transmission apparatus 100 in accordance with the present invention receives the setting of a display mode from the user via the user input unit 162 or receives the setting of a display mode via an application implemented as software on a portable mobile device, that is, the power reception terminal 200, so that the method of displaying information about the charged state of the wearable battery unit 130 and information about the transmission state of the power on the state information display unit 166 may be controlled.

Moreover, the power reception terminal 200 in accordance with the present invention receives information about the charged state of the wearable battery unit 130 and information about the transmission state of the power from the wearable wireless power transmission apparatus 100, and displays the information to the user in accordance with the execution of the application, so that the user can check the charged state of the wearable battery unit 130 and the transmission state of the power via the power reception terminal 200.

The present invention has the advantage of enabling the user to wirelessly charge a portable mobile device conveniently in an outdoor place where power cannot be supplied because power is generated from light energy or kinetic energy attributable to bodily activities using the energy harvesting means attachable to a garment or a bag worn or carried by a user and because the primary coil for wirelessly transmitting power to the secondary coil of the portable mobile device is configured of conductive fiber and implemented in the fabric of the garment or bag.

Furthermore, the present invention has the advantage of eliminating the user's inconvenience attributable to the frequent charging of a portable mobile device having high power consumption, such as a smart phone, and the advantage of enabling the user to charge the portable mobile device at a desired time and in a desired place because a power supply system can be made ubiquitous.

Moreover, the present invention has the advantage of applying wireless power supply technology to information technology (IT) sports items, such as a sports outdoor garment, a knapsack, and a backpack because the highly useful and convenient wireless power transmission apparatus can be provided as a charging means for a portable mobile device carried by the user when the user stays in an outdoor place where power cannot be supplied in order to enjoy outdoor activities, such as camping, mountain hiking, or cycling.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wearable wireless power transmission apparatus, comprising:
a wearable energy harvesting unit configured to generate power from at least one of light energy and kinetic energy, and to be attachable to fabric;
a wearable battery unit configured to store the power generated by the wearable energy harvesting unit, to be attachable and detachable to and from the fabric, and to be charged with external power when it is detached from the fabric;
a wearable power charging unit configured to rectify the power generated by the wearable energy harvesting unit, to charge the wearable battery unit with the power, and to be attachable and detachable to and from the fabric;
a wearable power transmission processing unit configured to generate a transmission signal to be used to wirelessly transmit the power stored in the wearable battery unit to a power reception terminal, and to be attachable and detachable to and from the fabric; and
a fiber-type primary coil unit configured to wirelessly transmit the transmission signal generated by the wearable power transmission processing unit to a secondary coil unit of the power reception terminal, configured of conductive fiber, and formed in the fabric.

2. The wearable wireless power transmission apparatus of claim 1, wherein the wearable energy harvesting unit includes a first power generation unit configured to generate power by converting light energy into electrical energy, and to be configured of a fiber-type solar cell.

3. The wearable wireless power transmission apparatus of claim 1, wherein the wearable energy harvesting unit includes a second power generation unit configured to generate power by converting kinetic energy into electrical energy, and to be configured of a fiber-type dielectric elastomer.

4. The wearable wireless power transmission apparatus of claim 1, wherein the wearable battery unit, the wearable power charging unit, and the wearable power transmission processing unit are implemented as a System On Package (SOP), and are configured as a single package that can be attachable and detachable to and from the fabric.

5. The wearable wireless power transmission apparatus of claim 1, further comprising a wearable state display unit configured to display at least one of a charged state of the wearable battery unit and a transmission state of the power transmitted from the fiber-type primary coil unit to the secondary coil unit, via a flexible light-emitting diode.

6. The wearable wireless power transmission apparatus of claim 5, wherein the wearable state display unit is configured such that a display mode thereof is controlled by manipulation of a user input unit provided in the wearable state display unit or by manipulation of the power reception terminal.

7. The wearable wireless power transmission apparatus of claim 6, wherein the display mode corresponds to any one of a constant ON mode, a constant OFF mode, a battery charged state display mode, a power transmission state display mode, and a flickering mode.

8. The wearable wireless power transmission apparatus of claim 5, wherein the wearable power charging unit includes:
a power input unit configured to receive alternating current (AC) power generated by the wearable energy harvesting unit, and to convert the AC power into direct current (DC) power; and
a power conversion unit configured to perform DC-DC conversion on the DC power obtained by the rectification of the power input unit, and to charge the wearable battery unit.

9. The wearable wireless power transmission apparatus of claim 8, wherein the wearable power charging unit further includes a charging state monitoring unit configured to monitor the charged state of the wearable battery unit.

10. The wearable wireless power transmission apparatus of claim 9, wherein the wearable power transmission processing unit includes:
a transmission signal generation unit configured to generate the transmission signal to be used to wirelessly transmit the power stored in the wearable battery unit to the power reception terminal; and
a transmission control unit configured to determine presence of the power reception terminal, and to control output of the transmission signal.

11. The wearable wireless power transmission apparatus of claim 10, wherein the wearable power transmission processing unit further includes a transmission state monitoring unit configured to monitor the transmission state of the power transmitted from the fiber-type primary coil unit to the secondary coil unit.

12. The wearable wireless power transmission apparatus of claim 11, wherein the charged state of the wearable battery unit monitored by the charging state monitoring unit or the transmission state of the power monitored by the transmission state monitoring unit is displayed on the power reception terminal.

13. A wearable wireless power transmission method, comprising:
generating, by a wearable energy harvesting unit attachable to fabric, AC power from at least one of light energy and kinetic energy;
converting, by a wearable power charging unit attachable and detachable to and from the fabric, the AC power into DC power;
storing, by a wearable battery unit attachable and detachable to and from the fabric, the DC power;
generating, by a wearable power transmission processing unit attachable and detachable to and from the fabric, a transmission signal to be used to wirelessly transmit the power stored in the wearable battery unit to a power reception terminal; and
wirelessly transmitting, by a fiber-type primary coil unit configured of conductive fiber and formed in the fabric, the transmission signal to a secondary coil unit of the power reception terminal;
wherein the wearable battery unit, the wearable power charging unit, and the wearable power transmission processing unit are implemented as an SOP, and are configured as a single package that can be attachable and detachable to and from the fabric.

14. The wearable wireless power transmission method of claim 13, further comprising:
monitoring, by the wearable power charging unit, a charged state of the wearable battery unit;
monitoring, by the wearable power transmission processing unit, a transmission state of the power transmitted from the fiber-type primary coil unit to the secondary coil unit; and
displaying, by a wearable state display unit, at least one of the charged state and the transmission state via a flexible light-emitting diode.

15. The wearable wireless power transmission method of claim 14, wherein displaying at least one of the charged state and the transmission state via the flexible light-emitting diode comprises displaying the charged state or the transmission state in accordance with a display mode that is controlled by manipulation of a user input unit provided in the wearable state display unit or by manipulation of the power reception terminal.

16. The wearable wireless power transmission method of claim 15, further comprising, displaying the charged state or the transmission state on the power reception terminal.
